(19) United States
(12) Patent Application Publication
(10) Pub. No.: US 2025/0328262 A1
(43) Pub. Date: Oct. 23, 2025

(54) Intelligent Secure Method to Orchestrate Coupling of Distributed Memory Storage Leveraging PCCO and DIP

(71) Applicant: Bank of America Corporation, Charlotte, NC (US)

(72) Inventors: Saurabh Garg, Faridabad (IN); Maneesh Kumar Sethia, Hyderabad (IN); Shailendra Singh, Maharashtra (IN)

(73) Assignee: Bank of America Corporation, Charlotte, NC (US)

(21) Appl. No.: 18/637,895

(22) Filed: Apr. 17, 2024

(51) Int. Cl. G06F 3/06

(52) U.S. Cl. CPC G06F 3/0622; G06F 3/0655; G06F 3/067

(57) ABSTRACT

Intelligent secure methods, processes, systems, and apparatus are disclosed for controlling and monitoring volatile memories in third-party vendor systems, such as an ATM or PoS, providing a solution to track and integrate memory components into the monitoring system of a customer's financial institution using scanning procedures, homomorphic encryption, and blockchain transactions to establish trust and ensure confidentiality by orchestrating the coupling of distributed memory storage located on the third-party vendor systems and/or hardware by leveraging PCCO (Parity Check Control Object) and DIP (Dependency Inversion Protocol).

### FIELD OF USE

The present disclosure relates to methods, processes, systems, and apparatus for identifying and addressing memory hardware wherein the methods, processes, systems, and apparatus involve significant data coupling, merging, manipulating, combining, translating, mapping, linking, and other techniques for accessing, formatting, and modifying data for storage. More particularly, methods, processes, systems, and apparatus for orchestrating the intelligent and secure coupling of distributed memory storage leveraging PCCO (Parity Check Control Object) and DIP (Dependency Inversion Protocol) are disclosed herein.

### BACKGROUND

Customer details are captured in the memory of various third-party vendor devices and systems used to process transactions by customers such as an Automated Teller Machines (ATM) or Point of Sale (POS) machines. The stored memory of such systems may be used by the related vendor hardware to support and execute the related transactions. Since the vendor devices, systems, and related hardware are proprietary, the customer's financial institution does not have control of the distributed memory storage and related data. As such, a customer's data privacy and information security may be at risk as the various vendor systems collect and store customer information. In particular, these third-party systems have memory storage that saves information without the bank's control or knowledge, thereby creating vulnerabilities.

It would be advantageous to track and identify the memory data and related memory components in these third-party systems and to integrate them into the bank's monitoring systems for control and alerting purposes. Accordingly, there is need to develop a technical procedure that can intelligently couple distributed memory storage located on third-party systems and related hardware with a customer financial institution for monitoring. The methods and systems disclosed herein may be used to monitor and secure memory storage components in a machine, such as an ATM or PoS.

### SUMMARY

In light of the foregoing background, the following presents a simplified summary of the present disclosure in order to provide a basic understanding of various aspects of the disclosure. This summary is not limiting with respect to the exemplary aspects of the inventions described herein and is not an extensive overview of the disclosure. It is not intended to identify key or critical elements of the disclosure or to delineate the scope of the disclosure. Instead, as would be understood by a personal of ordinary skill in the art, the following summary merely presents some concepts of the disclosure in a simplified form as a prelude to the more detailed description provided below.

In one aspect of the disclosure, a method for identifying and monitoring memory storage on a third-party transactional device is disclosed in accordance with one or more aspects described herein.

In one aspect of the disclosure, a method for identifying and monitoring memory storage on a third-party transactional device may include the steps of identifying a financial institution controlled software on a third-party transactional device, identifying third-party memory storage hardware on the third-party transactional device in which the third-party memory storage hardware may include customer data, and the customer may be a member of the financial institution, coupling the financial institution controlled software with the third-party memory hardware, identifying customer data stored on the third-party memory storage hardware, extracting and encrypting the customer data stored on the third-party memory storage hardware, establishing a communication channel between a server of the financial institution and the third-party memory hardware, transmitting the encrypted customer data to the server of the financial institution, and monitoring the third-party memory storage hardware on the third-party transactional device and the customer data.

In some examples, the third-party transactional device may be an Automatic Teller Machine (ATM). In other examples, the third-party transactional device may be a Point of Sale (POS) device. In another example, the financial institution data server or host may be a cloud environment. In some examples, the customer data may be encrypted via a homomorphic encryption layer. In yet other examples, the established communication channel may be via an existing circuit. In some examples, the financial institution controlled software or related customer data may be coupled with the third-party memory hardware or saved customer data on the hardware using a Security Information and Event Management (SEIM) logic. In other examples, the financial institution controlled software and the third-party memory hardware may communicate via RS232 and RS422 protocols. In still other examples, the financial institution may archive, store, modify, delete, manipulate, or purge the customer data saved on the identified memory storage hardware in the third-party transactional device. In yet other examples, the method may include the additional step of generating an alert. In certain examples, the alert may include information related to a change in the customer data stored on the third-party memory storage hardware and/or a change in the memory storage hardware on the third-party transactional device.

In another aspect of the disclosure, a system for identifying and monitoring memory storage on a third-party transactional device may include at least one processor, a vendor hardware scanning program, a storage memory identification engine, a hardware telemetry monitoring engine, and memory storing computer-readable instructions that, when executed by the at least one processor, may cause the system to scan via the vendor hardware scanning program, a third-party transactional device, identify via the storage memory identification engine, memory storage hardware in the third-party transactional device, and monitor via the hardware telemetry monitoring engine, the identified memory storage hardware on the third-party transactional device.

In some examples, the third-party transactional device may be an Automatic Teller Machine (ATM). In other examples, the third-party transactional device may be a Point of Sale (POS) device. In still other examples, the system disclosed herein may generate via the storage memory identification engine, a memory storage hardware profile of the third-party transactional device. In certain examples, the memory storage profile may include components of the third-party transactional device that includes or has saved the customer data. In still other examples, the system may extract via the hardware telemetry monitoring engine, customer data stored on the identified memory storage hardware. In one example, the customer may be a member of a financial institution identifying and monitoring the memory storage on the third-party transactional device. In yet another example, the identifying and monitoring of the memory storage hardware on the third-party transactional device may be in accordance with agreed upon protocols between the third-party and the financial institution. In other examples, the customer data may be encrypted via a homomorphic encryption layer, and transmitted to a network, server, or host of the financial institution. In still other examples, the financial institution may archive, store, modify, delete, manipulate, or purge the customer data stored on the identified memory storage hardware in the third-party transactional device. In one example, the system may identify via the storage memory identification engine, changes to the memory storage hardware in the third-party transactional device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts a sample, functional, architectural-block diagram showing sample interactions, steps, functions, and components of a process, method, system, and apparatus for orchestrating the coupling of distributed memory storage located on vendor machines and/or hardware by leveraging PCCO (Parity Check Control Object) and DIP (Dependency Inversion Protocol) in accordance with one or more aspects described herein.

FIG. 2 depicts distributed vendor machines and a vendor hardware controller apparatus in accordance with one or more aspects described herein.

FIG. 3 depicts a process, via a hardware controller apparatus, to scan, detect, identify, and monitor hardware in a third-party vendor transaction device in accordance with one or more aspects described herein.

FIG. 4 depicts a block diagram of an alternative vendor hardware controller apparatus in accordance with one or more aspects described herein in accordance with one or more aspects described herein.

### DETAILED DESCRIPTION

In the following description of the various embodiments to accomplish the foregoing, reference is made to the accompanying drawings, which form a part hereof, and in which is shown by way of illustration, various embodiments in which the disclosure may be practiced. It is to be understood that other embodiments may be utilized, and structural and functional modifications may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure, any number of computers, machines, or the like can include one or more general-purpose, customized, configured, special-purpose, virtual, physical, and/or network-accessible devices such as: administrative computers, application servers, clients, cloud devices, clusters, compliance watchers, computing devices, computing platforms, controlled computers, controlling computers, desktop computers, distributed systems, enterprise computers, instances, laptop devices, monitors or monitoring systems, nodes, notebook computers, personal computers, portable electronic devices, portals (internal or external), servers, smart devices, streaming servers, tablets, web servers, and/or workstations, which may have one or more application specific integrated circuits (ASICs), microprocessors, cores, executors, etc., for executing, accessing, controlling, implementing, etc., various software, computer-executable instructions, data, modules, processes, routines, or the like as discussed below.

References to computers, machines, or the like as in the examples above are used interchangeably in this specification and are not considered limiting or exclusive to any type(s) of electrical device(s), or component(s), or the like. Instead, references in this disclosure to computers, machines, devices, or the like are to be interpreted broadly as understood by skilled artisans. Further, as used in this specification, computers, machines, devices, or the like also include all hardware and components typically contained therein such as, for example, ASICs, processors, executors, cores, etc., display(s) and/or input interfaces/devices, network interfaces, communication buses, or the like, and memories or the like, which can include various sectors, locations, structures, or other electrical elements or components, software, computer-executable instructions, data, modules, processes, routines, etc. Other specific or general components, machines, or the like are not depicted in the interest of brevity and would be understood readily by a person of skill in the art.

As used throughout this disclosure, software, computer-executable instructions, data, modules, processes, routines, or the like can include one or more: active-learning, algorithms, algorithm-driven, alarms, alerts, applications, application program interfaces (APIs), artificial intelligence, approvals, asymmetric encryption (including public/private keys), attachments, big data, blockchains, blocks, CRON functionality, daemons, databases, datasets, datastores, DeFi functionality, drivers, data structures, deep learning modules (e.g., knowledge graphs, NLP, LSTM, GAN, etc.), distributed ledgers, distributed-ledger blockchains, distributed-ledger hash chains dynamic rule engines, engines, emails, extraction functionality, file systems or distributed file systems, firmware, governance rules, graphical user interfaces (GUI or UI), images, instructions, interactions, Java jar files, Java Virtual Machines (JVMs), juggler schedulers and supervisors, layers, load balancers, load functionality, logic, machine learning (supervised, semi-supervised, unsupervised, or natural language processing), metadata, middleware, modules, namespaces, objects, operating systems, optimization modules, platforms, plugins, processes, protocols, programs, rejections, routes, routines, rule deployment modules, security, scripts, tables, tools, transactions, transformation functionality, user actions, user interface codes, utilities, web application firewalls (WAFs), web servers, web sites, etc.

As used throughout this disclosure, computer “networks,” topologies, or the like can include one or more local area networks (LANs), wide area networks (WANs), the Internet, clouds, hosts, wired networks, wireless networks, digital subscriber line (DSL) networks, frame relay networks, asynchronous transfer mode (ATM) networks, virtual private networks (VPN), or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may utilize any transport that supports HTTPS or any other type of suitable communication, transmission, and/or other packet-based protocol. Decentralized networks (e.g., DeFi networks), in particular, are included in the foregoing and are protected by the information-security aspects of this disclosure.

The foregoing software, computer-executable instructions, data, engine, modules, plugins, processes, programs, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like (e.g., in a decentralized network that may include a consortium of networks, entities, institutions, etc.) including memory and other components thereof. Some or all the foregoing may additionally and/or alternatively be stored similarly and/or in a distributed manner in the network accessible storage/distributed data/datastores/databases/big data/blockchains/distributed-ledger blockchains/distributed ledger hash chains/hash chain network/hashed mesh, etc.

Digital and cryptocurrency transactions in a blockchain may be executed on a third-party-transaction device and recorded in blocks through a process that involves several steps. This process ensures the integrity, transparency, and security of transactions on the blockchain, which is the underlying technology of digital transactions, cryptocurrencies like Bitcoin, Ethereum, and many others. A customer or user may initiate a transaction by sending cryptocurrency from their wallet to another person's wallet address. This transaction includes the amount of cryptocurrency being sent, the sender's and recipient's/counterpart's wallet addresses, and typically a transaction cost. The transaction is signed with the sender's private key, serving as a digital signature to verify the authenticity of the transaction and that the sender has the authority to transfer the funds. Once signed, the transaction is broadcasted to the cryptocurrency network, where it is propagated to various nodes (i.e., computers and/or servers in the network). These nodes temporarily hold the transaction in their memory pool (mempool), awaiting confirmation and inclusion in a block. Nodes, or in the case of Bitcoin and many other cryptocurrencies, specialized nodes called miners, verify the transaction. This verification process includes checking the digital signature against the sender's public key and ensuring the sender has sufficient balance to cover the transaction and costs. Verified transactions are collected by miners and grouped together to form a new block. In cryptocurrencies that use Proof of Work, such as Bitcoin, miners compete to solve a complex mathematical puzzle related to the new block. The first miner to solve the puzzle gets the right to add the new block to the blockchain. Other cryptocurrencies may use different consensus mechanisms, such as Proof of Stake, which selects validators in proportion to their quantity of holdings in the cryptocurrency to create new blocks, or Delegated Proof of Stake, which involves election of delegate validators.

Once a block is completed and verified through the validation mechanism, it is added to the blockchain. This new block includes a reference to the hash of the previous block, creating a secure, unbreakable chain of blocks. The addition of the new block to the blockchain is broadcasted across the network. Nodes update their copies of the blockchain to include the new block. This update confirms the transactions contained within the block across the entire network. With the block added to the blockchain, the transactions within it are considered confirmed. This process typically requires a number of additional blocks to be added after the initial block, to ensure irreversibility-a security measure against double spending. In Proof of Work (PoW) systems, the miner who successfully adds a block to the blockchain receives a reward in the form of newly minted cryptocurrency (e.g., Bitcoin) and transaction costs from the transactions within the block. This process ensures that cryptocurrency transactions are securely and transparently recorded on the blockchain, making it extremely difficult to alter historical data or conduct fraudulent transactions without the consensus of the network.

Typically, ATM systems and networks operated by a customer's financial institution provides various financial services for its customers (e.g., cash withdrawal, deposits, account information, etc.). These networks, which may comprise thousands of ATMs for some larger banks, may be monitored for any potential issues (e.g., data or other security breaches, network outages, mechanical faults, etc.). Customer financial institutions, however, cannot monitor third-party systems to the extent they can monitor their own systems. Accordingly, the methods and systems disclosed relate to controlling and monitoring volatile memories in third-party systems, by tracking and integrating memory components into the customer's financial institution's own monitoring systems by using scanning procedures, homomorphic encryption, and blockchain transactions to establish trust and ensure confidentiality in the third-party systems.

Transactions may also be via point of sale (POS) device(s) or via website-based online interfaces (e.g., associated with online shopping portals, or bill payment interfaces, etc.). A payment processing server may receive a request for a card-based transaction, such as when a user uses a credit/debit card at the POS device or an online interface, and forwards information associated with the transaction to the enterprise application host platform or server. A merchant name associated with the transaction, a description associated with the transaction, a transaction value, credit card/debit card information (e.g., card number, card verification value) may be save in the device memory.

An objective of the systems and methods disclosed herein is to control and monitor the volatile memories distributed on various devices, such as third-party automatic teller machines and point of sale devices. As discussed above, third-party devices have memory storage that stores information without a customer financial institution's control or knowledge, thus creating vulnerabilities related to the customer's data and privacy rights. The methods and systems disclosed herein provide the financial institution the ability to track and identify the memory components in these third-party systems and integrate them into the financial institution's own monitoring systems for control and monitoring purposes.

In some aspects, the methods and systems are designed to monitor and secure storage components in a machine or other system, such as an ATM or PoS. In some examples, the methods and systems disclosed herein may use scanning procedures to identify storage systems and continuously updates the baseline components. In other examples, the methods and systems disclosed herein may use homomorphic encryption to ensure the confidentiality of sensitive information. In still other examples, the methods and systems disclosed herein may be used to control risk, to monitor proprietary hardware, and to detect external memory in third-party vendor machines and systems. In yet other examples, the methods and systems disclosed herein may establish trust between the third-party vendor system hardware and the customer financial institution through blockchain transactions.

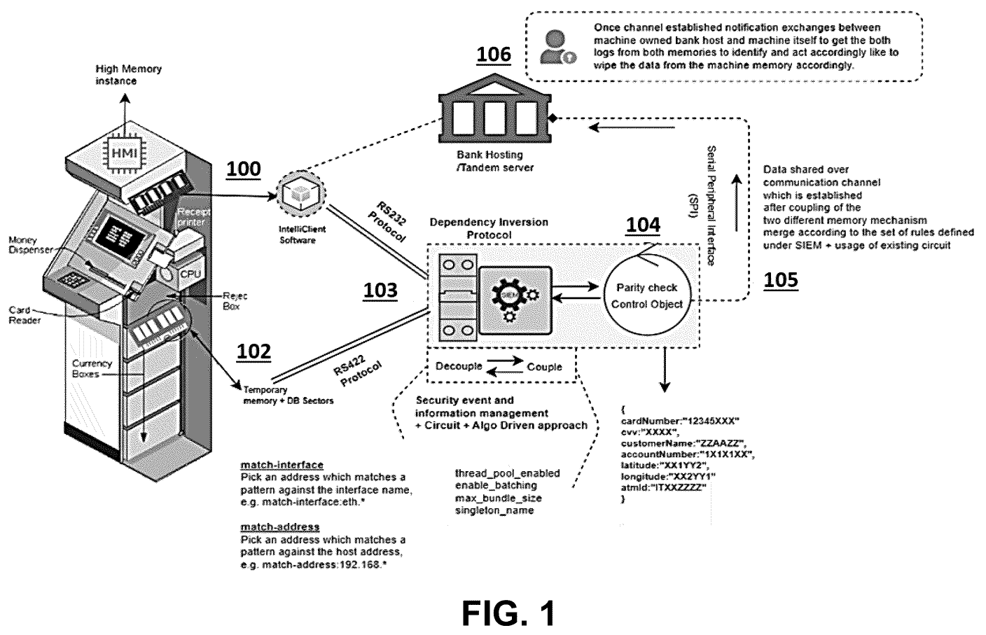

By way of non-limiting disclosure, FIG. 1 depicts a sample, functional, architectural-block diagram showing sample interactions, steps, functions, and components of a process, method, system, and apparatus for orchestrating the coupling of distributed memory storage located on vendor machines and/or hardware by leveraging PCCO (Parity Check Control Object) and DIP (Dependency Inversion Protocol) in accordance with one or more aspects described herein.

As shown in FIG. 1, a third-party ATM may include a financial institution enabled software. The software is configured to provide a customer of the financial institution the ability to conduct transactions at the third-party ATM.

At step 100, the information for a customer of a particular financial institution may be identified and transmitted to a dependency inversion protocol. The information can come from a customer's card where the information may be stored on the magnetic strip (e.g., card number, etc.).

At step 102, the customer data stored in the identified ATM memory storage hardware is transmitted to the dependency inversion protocol. The customer data may be stored as temporary memory in an in-memory database sector of the ATM. The third-party ATM may be scanned by a vendor hardware controller apparatus to identify memory storage hardware of the third-party ATM and to continuously monitor the memory hardware telemetry (e.g., input/output voltage to identify potential memory storage on vendor hardware that would be identified and coupled to a financial institution server or host).

At step 103, the information for the customer of a particular financial institution from step 100, and the customer data stored in the identified ATM memory storage hardware from step 102, are merged via the dependency inversion protocol. Standard communication protocols such as RS232 and RS422 may be used to ensure that a secure communication channel is established within distributed memory environments, and in certain examples, within the same machine.

At step 103, the decoupled memory data from the ATM memory storage hardware, as well as the financial institution enabled software application memory data, may be coupled, or merged, by using a machine internal logic circuit to ensure a tamper-proof exchange of the memory data. As disclosed herein, the method and system may be used for any third-party vendor machine that requires secure communications. Accordingly, the methods and systems disclosed herein provide an extremely flexible solution for secure communication requirements. In some examples, a Security Information and Event Management (SIEM) logic may be used to understand the communications between the two different memories via protocols RS232 and RS422. In other examples, the memories may be coupled using an address that matches a pattern against the interface name (e.g., match_interface) and an address that matches a pattern against the host address (e.g., match_address), as well as combinations of other parameters (e.g., thread_pool_enabled, enable_batching, max_bundle_size, and singleton_name).

At step 104, a Parity Check Control Object (PCCO) including a set of rules with message packet event parameters, may be used to verify the coupled memories from step 103. Message packet event parameters may be based on a Banking Institution Code (BIC) as shown in the following example:
{
cardNumber: “12345XXX”
cvv: “XXXX”,
customerName: “ZZAAZZ”,
accountNumber: “1X1X1XX”,
atmId: “ITXXZZZZ”
}

At step 105, an Introduced Serial Peripheral Interface (SPI) logic having an algorithm driven approach may be used to share the coupled memory data. The data may be shared over a communication channel that may be established with the financial institution server or host after coupling of the two different memory mechanisms that are merged according to a set of rules defined under the SIEM logic and usage of an existing system circuit.

At step 106, notification exchanges may take place over the communication channel established with the financial institution server or host and the third-party ATM. Logs from both memories may be used to identify saved customer information or to identify changes to the memory hardware of the third-party machine. The financial institution may then archive, store, modify, delete, manipulate, or purge the customer data stored on the identified memory storage hardware in the third-party machine if the financial institution has identified a risk or threat to the customer related data or to the customer's privacy. The financial institution server or host may store the information from the Dependency Inversion Protocol (DIP) in an encrypted form. In some examples, the information may be saved in a blockchain as previously described.

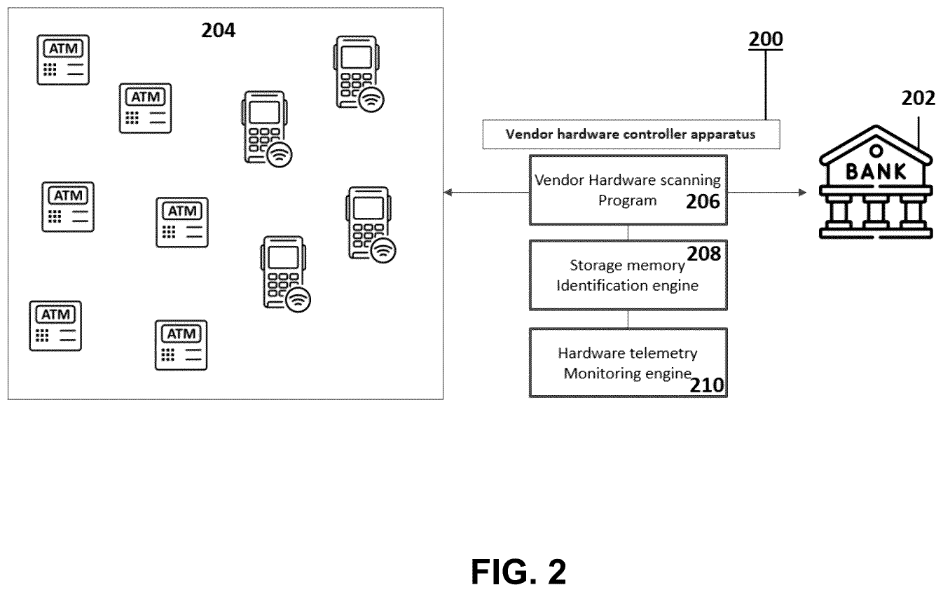

By way of non-limiting disclosure, FIG. 2 depicts distributed vendor machines and a vendor hardware controller apparatus in accordance with one or more aspects described herein. Vendor hardware controller apparatus 200 may be used to link a financial institution 202 with vendor machines 204. By linking financial institution 202, via the vendor hardware controller apparatus 200, with vendor machines 204, the financial institution may scan, identify, and monitor the memory storage hardware of vendor machines 204 to protect customer information. Typical vendor machines 204 may include ATMs and PoS devices as previously discussed.

Vendor hardware controller apparatus 200 may include vendor hardware scanning program 206, storage memory identification engine 208, and hardware telemetry monitoring engine 210. Vendor hardware controller apparatus 200 may be configured to scan the hardware of vendor devices 204 to identify the components of the hardware that may be behaving as a storage medium, and monitor the detected storage mediums. For example, the vendor hardware controller apparatus 200 may scan, detect, and identify hardware in a vendor device 204 that is dedicated to tracking an individual's particular transaction, but vendor hardware controller apparatus 200 may also be configured to scan, detect, and identify other memory that is storage for information not related to the transaction (e.g., sensor data, currency level, etc.). By identifying and monitoring the various types storage mediums detected on vendor devices 204, the financial institution may detect anomalies or manipulation of vendor devices 204 that may put a customer at risk. For example, each detected storage medium on vendor device 204 may be scanned to determine if a customer's card information is stored in an alternative location on vendor device 204, in the event the device was manipulated. In other examples, the financial institution may have access to control the memory storage hardware to archive, store, modify, delete, manipulate, or purge the customer data saved on the identified memory storage hardware as disclosed herein.

Vendor hardware scanning program 206 may be configured to scan vendor machines or devices 204 for financial institution related software that may contain customer information or other data, as well as to scan vendor machines or devices 204 for memory storage hardware. Storage memory identification engine 208 may be configured to detect and/or identify a particular type of memory hardware (e.g., EEPROM, flash memory, etc.) within vendor devices 204. Additionally, storage memory identification engine 208 may be further configured to identify saved customer data in vendor machines 204. Storage memory identification engine 208 may determine the type and capacity of memory, how information is stored, the particular medium, frequency, etc.

Hardware telemetry and monitoring engine 210 may be used to continuously or periodically monitor memory storage hardware embedded in vendor devices 204. Hardware telemetry and monitoring engine 210 may be used to determine if vendor device 204 is scanning the memory, manipulating the memory, or purging the memory. Hardware telemetry and monitoring engine 210 may be used to detect and monitor input/output voltage at various circuits to further identify chips (e.g., memory, RAM, flash drive, non-memory component, etc.). If a change in memory storage hardware is detected by hardware telemetry and monitoring engine 210, an alert may be sent to the financial institution. The financial institution may take appropriate action in view of the alert and updated memory storage hardware such as deleting, archiving, storing, modifying, or purging customer data stored on the identified memory storage hardware in the vendor devices 204.

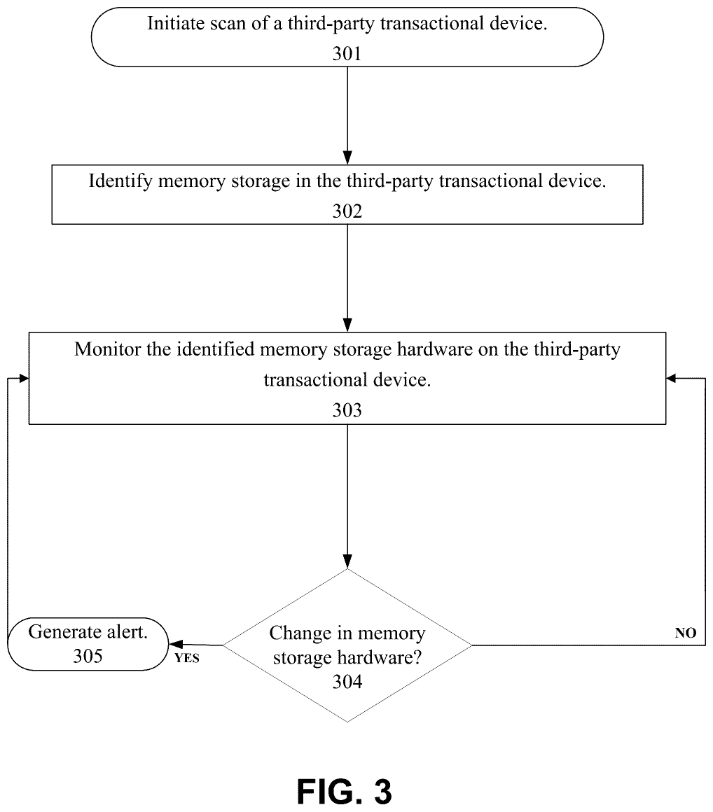

By way of non-limiting disclosure, FIG. 3 depicts a process, via a hardware controller apparatus, to scan, detect, identify, and monitor hardware in a third-party vendor transaction device as previously discussed and in accordance with one or more aspects described herein.

At step 301, a hardware controller apparatus may initiate a scan of a third-party vendor device to detect hardware operating as a storage medium.

At step 302, the hardware controller apparatus may identify the particular type of memory storage hardware detected on the third-party vendor device.

At step 303, the hardware controller apparatus may continuously monitor the memory storage hardware detected on the third-party vendor device. In other examples, the hardware controller apparatus may monitor the memory storage hardware detected on the third-party vendor device in regular intervals, and/or at random intervals.

At step 304, the hardware controller apparatus may detect a change to the memory storage hardware detected on the third-party vendor device. In some examples, the hardware controller apparatus may detect a change to the data stored on the memory storage hardware detected on the third-party vendor device. In yet another example, the hardware controller apparatus may detect a change to customer data stored on the memory storage hardware detected on the third-party vendor device. If no change is detected, the hardware controller apparatus may continue to monitor the memory storage hardware detected on the third-party vendor device. If a change is detected, an alert may be generated at step 305.

At step 305, the hardware controller apparatus generates an alert indicating a detected change to the memory storage hardware detected on the third-party vendor device. The alert may be transmitted to the customer's financial institution. In response to the generated alert, the financial institution may archive, store, modify, delete, manipulate, or purge the customer data saved on the identified memory storage hardware in the third-party transactional device. In one example, the financial institution may alert the customer of the change in response to the generated alert. For example, if the third-party vendor device was manipulated to collect and save customer data for fraudulent purposes, the financial institution may alert the customer as to the potential risk of personal data and privacy.

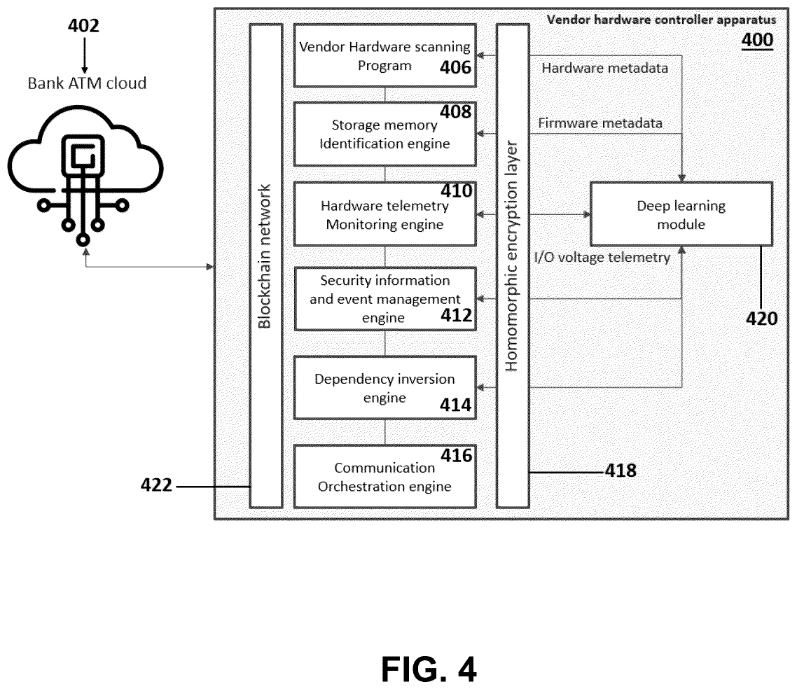

By way of non-limiting disclosure, FIG. 4 depicts a block diagram of an alternative vendor hardware controller apparatus 400 in accordance with one or more aspects described herein in accordance with one or more aspects described herein.

As discussed above, vendor hardware controller apparatus 400 may include vendor hardware scanning program 406, storage memory identification engine 408, and hardware telemetry monitoring engine 410. Vendor hardware controller apparatus 400 may be configured to scan the hardware of vendor devices 404 to identify the components of the hardware that may be behaving as a storage medium, and monitor the detected storage mediums. Vendor hardware controller apparatus 400 may interface with a financial institution server or host, or as shown in FIG. 4, a cloud environment as disclosed herein.

Vendor hardware scanning program 406 may be configured to scan third-party vendor machines or devices for financial institution related software that may contain customer information or other data, as well as to scan third-party vendor machines or devices for embedded memory storage hardware. Storage memory identification engine 408 may be configured to detect and/or identify a particular type of memory hardware within the third-party vendor devices. Additionally, storage memory identification engine 408 may be further configured to identify saved customer data in the third-party vendor machines. Storage memory identification engine 408 may determine the type and capacity of memory, how information is stored, the particular medium, frequency, etc.

Hardware telemetry and monitoring engine 410 may be used to continuously or periodically monitor memory storage hardware embedded in the third-party vendor devices. Hardware telemetry and monitoring engine 410 may be used to determine if the vendor device is scanning the memory, manipulating the memory, or purging the memory. As discussed above, hardware telemetry and monitoring engine 410 may be used to detect and monitor input/output voltage at various circuits to further identify chips. Hardware telemetry and monitoring engine 410 may be used to monitor baseline components of the third-party vendor hardware as well as monitor routine maintenance to the components. If a change in memory storage hardware, or a change to the memory hardware storage, is detected by hardware telemetry and monitoring engine 410, an alert may be generated and transmitted to the financial institution. The financial institution may take appropriate action in view of the alert and updated memory storage hardware such as deleting, archiving, storing, modifying, or purging customer data stored on the identified memory storage hardware in the third-party vendor devices. In some examples, an alert may be generated and sent to the customer of the financial institution.

As also shown in FIG. 4, vendor hardware controller apparatus may further include security information and event management engine 412, dependent inversion engine 414, and communication orchestration engine 416. Security information and event management engine 412 may be configured to determine the exact functions of the memory storage hardware and/or the functions of other baseline components of the third-party vendor device. Dependent inversion engine 414 may be configured to securely couple or merge financial institution customer data with the customer data stored in the memory storage of the third-party vendor device. Communication orchestration engine 416 may be configured to communicate/transmit the extracted confidential information to financial institution cloud 402.

Homomorphic encryption layer 418 may be configured to encrypt extracted proprietary information from the third-party vendor memory storage hardware. In certain examples, the extracted data may be analyzed at the encryption layer to maintain security of the extracted data.

Deep learning module 420 may be configured to assess extracted data from the third-party vendor device and/or assess memory storage hardware detected and identified on the third-party vendor. Deep learning module 420 may use probabilities to determine and understand, using component parameters, input/output voltage, etc., if a component is memory storage. In some examples, deep learning module 420 may use input/output voltage telemetry data, and/or firmware metadata, and/or hardware metadata, to assign a probability that an identified component is memory storage hardware.

In some examples, vendor hardware controller apparatus 400 may include blockchain network 422. Blockchain network 422 may be configured to execute the methods disclosed herein as a blockchain transaction. The blockchain transaction, for example, may include detected and identified memory storage hardware within the third-party vendor device. In other examples, the blockchain transaction may include identified proprietary hardware, confirmed by the third-party vendor, that the component is proprietary hardware. In some examples, the proprietary hardware may then be analyzed with the third-party owner consent.

One or more aspects discussed herein may be embodied in computer-usable or readable data and/or computer-executable instructions, such as in one or more plugins, executed by one or more computers or other devices as described herein. Generally, plugin include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the plugin may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method for identifying and monitoring memory storage on a third-party transactional device, wherein each of the foregoing steps are performed by a computing device comprising at least one processor, a communication interface, and memory, comprising the steps of:
identifying a financial institution controlled software on a third-party transactional device;
identifying third-party memory storage hardware on the third-party transactional device, wherein the third-party memory storage hardware comprises customer data, and wherein the customer is a member of the financial institution;
coupling the financial institution controlled software with the third-party memory hardware;
identifying customer data stored on the third-party memory storage hardware;
extracting and encrypting the customer data stored on the third-party memory storage hardware;
establishing a communication channel between a server of the financial institution and the third-party memory hardware;
transmitting encrypted customer data to the server of the financial institution; and
monitoring the third-party memory storage hardware on the third-party transactional device and the customer data.

2. The method of claim 1, wherein the third-party transactional device is an Automatic Teller Machine (ATM).

3. The method of claim 1, wherein the third-party transactional device is a Point of Sale (POS) device.

4. The method of claim 1, wherein the financial institution server is a cloud environment.

5. The method of claim 1, wherein the customer data is encrypted via a homomorphic encryption layer.

6. The method of claim 6, wherein the established communication channel is via an existing circuit.

7. The method of claim 1, wherein the financial institution controlled software is coupled with the third-party memory hardware using Security Information and Event Management (SEIM) logic.

8. The method of claim 7, wherein the financial institution controlled software and the third-party memory hardware communicate via RS232 and RS422 protocols.

9. The method of claim 1, wherein the financial institution archives, stores, modifies, or purges the customer data stored on the identified memory storage hardware in the third-party transactional device.

10. The method of claim 1, further comprising generating an alert, wherein the alert comprises information related to a change in the customer data stored on the third-party memory storage hardware.

11. The method of claim 1, further comprising generating an alert, wherein the alert comprises information related to a change in the memory storage hardware on the third-party transactional device.

12. A system for identifying and monitoring memory storage on a third-party transactional device comprising:
at least one processor;
a vendor hardware scanning program;
a storage memory identification engine;
a hardware telemetry monitoring engine; and
memory storing computer-readable instructions that, when executed by the at least one processor, cause the system to:
scan, via the vendor hardware scanning program, a third-party transactional device;
identify, via the storage memory identification engine, memory storage hardware in the third-party transactional device; and
monitor, via the hardware telemetry monitoring engine, the identified memory storage hardware on the third-party transactional device.

13. The system of claim 12, wherein the third-party transactional device is an Automatic Teller Machine (ATM).

14. The system of claim 12, wherein the third-party transactional device is a Point of Sale (POS) device.

15. The system of claim 12, further comprising generating, via the storage memory identification engine, a memory storage hardware profile of the third-party transactional device, wherein the memory storage profile includes components of the third-party transactional device comprising the customer data.

16. The system of claim 15, further comprising the step of extracting, via the hardware telemetry monitoring engine, customer data stored on the identified memory storage hardware, wherein the customer is a member of a financial institution identifying and monitoring the memory storage on the third-party transactional device, and wherein the identifying and monitoring of the memory storage hardware on the third-party transactional device is in accordance with agreed upon protocols between the third-party and the financial institution.

17. The system of claim 16, wherein the customer data is encrypted, via a homomorphic encryption layer, and transmitted to a network of the financial institution.

18. The system of claim 17, wherein the financial institution archives, stores, modifies, or purges the customer data stored on the identified memory storage hardware in the third-party transactional device.

19. The system of claim 12, further comprising identifying, via the storage memory identification engine, changes to the memory storage hardware in the third-party transactional device.

20. A non-transitory machine-readable medium storing instructions that, when executed by one or more processors, cause the one or more processors to perform steps comprising:
scanning, via a vendor hardware scanning program, a third-party transactional device;
identifying, via a storage memory identification engine, memory storage hardware in a third-party transactional device; and
monitoring, via a hardware telemetry monitoring engine, the identified memory storage hardware on the third-party transactional device,
wherein the third-party transactional device is an Automatic Teller Machine (ATM) or a Point of Sale (POS) device,
wherein the identified memory storage hardware of the third-party transactional device comprises stored customer data, and
wherein the customer is a member of a financial institution identifying and monitoring the memory storage on the third-party transactional device.
